(19) United States
(12) Patent Application Publication
(10) Pub. No.: US 2016/0197360 A1
(43) Pub. Date: Jul. 7, 2016

(54) FUEL CELL SEPARATING PLATE AND METHOD OF MANUFACTURING THE SAME

(71) Applicant: HANKOOK TIRE CO., LTD., Seoul (KR)

(72) Inventors: Jae Wook Ihm, Daejeon (KR); Jeong Heon Kim, Daejeon (KR)

(21) Appl. No.: 14/982,254

(22) Filed: Dec. 29, 2015

(30) Foreign Application Priority Data
Jan. 2, 2015 (KR) 10-2015-0000100

(51) Int. Cl. H01M 8/0243; H01M 8/0234; H01M 8/0245; H01M 8/0239

(52) U.S. Cl. CPC H01M 8/0243; H01M 8/0239; H01M 8/0234; H01M 8/0245

(57) ABSTRACT

Disclosed are a fuel cell separating plate having high temperature and acid resistance, and a method of manufacturing the same. The fuel cell separating plate includes a molded product manufactured from a mixture of expanded graphite and thermoplastic resin.

The fuel cell separating plate and the method of manufacturing the same according to the present invention do not lower conductivity of the separating plate while decreasing a use amount of a conductive material. In addition, the fuel cell separating plate and the method of manufacturing the same simplify a manufacturing process and shorten manufacturing time.

### CROSS-REFERENCE TO RELATED APPLICATIONS

This U.S. utility patent application claims the benefit of priority under 35 U.S.C. §119 of Korean Patent Application No. 10-2015-0000100, filed Jan. 2, 2015, the entire contents of which are hereby incorporated herein by reference for all purposes.

### TECHNOLOGICAL FIELD

The present disclosure relates to a fuel cell separating plate and a method of manufacturing the same, and more particularly to a fuel cell separating plate having high temperature and acid resistance, and a method of manufacturing the same.

### BACKGROUND

Fuel cells are cells assembled so as to electrochemically generate oxidation of fuel, for example, hydrogen, phosphoric acid, methanol, etc. and thus directly convert free energy change accompanied by the oxidation into electric energy. Fuel cells are classified into solid oxide fuel cells (SOFC), phosphoric acid fuel cells (PAFC), proton exchange membrane fuel cells (PEMFC), direct methanol fuel cells (DMFC), etc., depending upon the types of fuels and reactive catalysts.

A separating plate for separating electrolyte, an anode, and a cathode from each other, as one of stack components of fuel cells requires properties such as electrical conductivity, gas permeability, strength, corrosion resistance, and elution inhibition effects. As materials of such a separating plate, metal, graphite, or the like is used. While metal separating plates have a drawback such as corrosivity, graphite separating plates have drawbacks such as high manufacturing costs and large volume. Accordingly, a separating plate is molded through compression-molding and injection-molding after mixing a thermosetting resin or a thermoplastic resin with a graphite powder.

In particular, when a fuel cell separating plate for high temperature is manufactured, a phenolic resin, epoxy resin, or the like is used as a thermosetting resin, and super engineering plastic stable at 150° C. or more is used as a thermoplastic resin.

In regard to a method of manufacturing a high temperature and acid-resistant fuel cell separating plate, US Patent Laid-Open Publication No. 2010-0307681 discloses a method of manufacturing a three-layer separating plate wherein a flat plate is inserted between two plates in which flow channels are formed. However, in regard to manufacturing such a plate, three or more molding processes are required and thus it takes a long time to manufacture the same. In addition, since three or more molds are required, a manufacturing process thereof is very complex.

### SUMMARY OF THE DISCLOSURE

Therefore, it is an object of the presently described embodiments to provide a fuel cell separating plate and a method of manufacturing the same wherein a manufacturing process of the fuel cell separating plate is simple and effective while decreasing a use amount of a conductive material such as graphite, without reduction of conductivity of a separating plate.

In accordance with an aspect of the present disclosure, the above and other objects can be accomplished by the provision of a fuel cell separating plate including a molded product manufactured from a mixture of expanded graphite and thermoplastic resin. Here, the thermoplastic resin may be a fluorocarbon polymer, and the fluorocarbon polymer may be fluorinated ethylene propylene (FEP), polytetrafluoroethylene (PTFE), perfluoroalkoxy (PFA), or a combination thereof.

The molded product may include 60 to 90 wt % of the expanded graphite and 10 to 40 wt % of the fluorocarbon polymer, particularly 60 to 70 wt % of the expanded graphite and 30 to 40 wt % of the fluorocarbon polymer.

In addition, the molded product according to a presently described embodiment may include a layer containing a small amount of graphite, including the expanded graphite and the thermoplastic resin, and a layer containing a high amount of graphite, including the thermoplastic resin in a smaller amount than the layer containing a small amount of graphite and disposed on two opposite sides of the layer containing a small amount of graphite.

Here, the layer containing a small amount of graphite may include 60 to 90 wt % of the expanded graphite and 10 to 40 wt % of the fluorocarbon polymer, and the layer containing a high amount of graphite may include 91 to 95 wt % of the expanded graphite and 5 to 9 wt % of the fluorocarbon polymer.

In addition, the layer containing a small amount of graphite may include 60 to 90 wt % of the expanded graphite and 10 to 40 wt % of the fluorocarbon polymer, and the layer containing a high amount of graphite may include 85 to 92 wt % of natural graphite flakes and 8 to 15 wt % of the fluorocarbon polymer.

According to an embodiment, the layer containing a high amount of graphite may have a porosity of 0.1 to 10 cc/min or more.

In accordance with another aspect described herein, there is provided a method of manufacturing a fuel cell separating plate, the method including mixing expanded graphite and thermoplastic resin, and molding a mixture of the expanded graphite and the thermoplastic resin. Here, the molding may include compression-molding the mixture at 280 to 360° C. for 1 to 20 minutes.

In addition, the mixing may include extrusion-molding the expanded graphite and the fluorocarbon polymer, and the molding may include injection-molding the mixture at 280 to 360° C. for 1 to 20 minutes.

In addition, the molding may include extruding the mixture to prepare a sheet, and compression-molding the sheet at 280 to 360° C. for 1 to 20 minutes.

In another embodiment described herein, the mixing may include preparing a first carbon composite by mixing 60 to 90 wt % of the expanded graphite and 10 to 40 wt % of the fluorocarbon polymer, and preparing a second carbon composite by mixing 91 to 95 wt % of the expanded graphite and 5 to 9 wt % of the fluorocarbon polymer; and the molding may include preparing a multilayer sheet by rolling the first carbon composite and the second carbon composite such that a layer containing a small amount of graphite, composed of the first carbon composite is disposed between two layers containing a high amount of graphite, composed of the second carbon composite, and compression-molding the multilayer sheet at 280 to 360° C. for 1 to 20 minutes.

In still another embodiment, the mixing may include preparing a first carbon composite including 60 to 90 wt % of the expanded graphite and 10 to 40 wt % of the fluorocarbon polymer, and preparing a second carbon composite including 85 to 92 wt % of natural graphite flakes and 8 to 15 wt % of the fluorocarbon polymer; and the molding may include preparing a multilayer sheet by rolling the first carbon composite and the second carbon composite such that a layer containing a small amount of graphite, composed of the first carbon composite is disposed between two layers containing a high amount of graphite, composed of the second carbon composite, and compression-molding the multilayer sheet at 280 to 360° C. for 1 to 20 minutes.

In addition, the method of manufacturing a fuel cell separating plate may further include, after the molding, removing the thermoplastic resin distributed on a surface of the molded separating plate. Here, the removing may include removing the thermoplastic resin through blasting.

When the fuel cell separating plate and the method of manufacturing the same according to the present disclosure are used, a use amount of a conductive material is decreased and conductivity of the separating plate is not decreased.

When the fuel cell separating plate and the method of manufacturing the same according to the present invention are used, a manufacturing process is simplified and manufacturing time is shortened.

When the fuel cell separating plate and the method of manufacturing the same according to the present invention are used, high electrical conductivity and air tightness are exhibited.

In addition, when the fuel cell separating plate and the method of manufacturing the same according to the present disclosure are used, superior injection-moldability is exhibited and thickness variation of a separating plate during compression-molding is small.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view schematically illustrating a fuel cell separating plate according to an embodiment.

### DETAILED DESCRIPTION

Hereinafter, the fuel cell separating plate and method of manufacture will be described more fully with reference to the accompanying drawings, in which exemplary embodiments are shown. The fuel cell separating plate and method of manufacture may, however, be embodied in many different forms and should not be construed as being limited to the embodiments set forth herein; rather, these embodiments are provided so that this disclosure will be thorough and complete, and will fully convey the disclosed concepts to those skilled in the art.

Terms used in the specification are used to describe specific embodiments and it should not be understood as limiting the scope of the claims. An expression used in the singular encompasses the expression of the plural, unless it has a clearly different meaning in the context. Also, it is to be understood that terms such as “comprise” and/or “have” are intended to indicate the existence of the features, numbers, steps, actions, components, parts, or combinations thereof, and are not intended to preclude the possibility that one or more other features, numbers, steps, actions, components, parts, or combinations thereof may exist or may be added.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, a fuel cell separating plate according to an embodiment is described in detail. A fuel cell separating plate according to a first embodiment includes a molded product formed from a mixture of expanded graphite and thermoplastic resin. As the thermoplastic resin, polyacrylate, polysulfone, polyethersulfone, polyphenylenesulfide, polyetherether ketone, polyimide, polyetherimide, a fluorocarbon polymer, a liquid crystal polymer, or the like, which is stable at high temperature, may be used.

Thereamong, the fluorocarbon polymer such as polyvinyldene fluoride, polytetrafluoroethylene (PTFE), perfluoroalkoxy (PFA), or fluorinated ethylene propylene is preferred. In addition, as polymers applied to PAFC that operates under a condition of 200° C. and a phosphoric acid concentration of 90% or more, FEP, PTFE, PFA or a combination thereof having excellent acid resistance is more preferable.

In addition, in an embodiment, the molded product of the fuel cell separating plate may include 60 to 90 wt % of the expanded graphite and 10 to 40 wt % of the fluorocarbon polymer. Since the expanded graphite has high conductivity, compared to general natural graphite, conductivity of the separating plate is not decreased due to use of the expanded graphite even when graphite is added in a small amount. In addition, a high temperature- and acid-resistant fuel cell separating plate, from which gas is not leaked, may be manufactured.

Accordingly, the high temperature- and acid-resistant fuel cell separating plate according to the embodiment may be used in fuel cells such as DMFC, PEMFC, and PAFC.

In addition, in the molded product of the fuel cell separating plate according to the embodiment, the content of the fluorocarbon polymer may be increased to 30 to 40 wt % so as to facilitate injection-molding.

In addition, in the embodiment, the molded product may be manufactured by compressing, injecting, or extruding the mixture of the expanded graphite and the thermoplastic resin. A method of manufacturing this molded product is described in detail in examples of the following method of manufacturing the fuel cell separating plate.

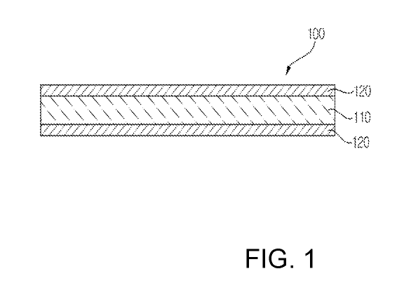

Referring to FIG. 1, a fuel cell separating plate according to a second embodiment is described in detail below. Since configurations except those described below are the same as those for the fuel cell separating plate according to the first embodiment, descriptions thereof are omitted.

A molded product of a fuel cell separating plate 100 according to a second embodiment includes a layer containing a small amount of graphite 110, which includes the expanded graphite and the thermoplastic resin, and layers containing a high amount of graphite 120, which include the graphite in a higher content and the thermoplastic resin in a smaller content than in the layer containing a small amount of graphite 110, are disposed on two opposite side of the layer containing a small amount of graphite 110. Here, the layers containing a high amount of graphite 120 may be formed in order to have a porosity of 0.1 to 10 cc/min or more.

Here, the layer containing a small amount of graphite 110 may include 60 to 90 wt % of the expanded graphite and 10 to 40 wt % of the fluorocarbon polymer. The layers containing a high amount of graphite 120 may include 91 to 95 wt % of the expanded graphite and 5 to 9 wt % of the fluorocarbon polymer.

In another embodiment, the layers containing a high amount of graphite 120 may include 85 to 92 wt % of natural graphite flakes and 8 to 15 wt % of the fluorocarbon polymer. Here, fluorocarbon polymer may be FEP, PTFE, PFA or a combination thereof.

The molded product according to the present invention may be manufactured by rolling or compressing the mixture of the expanded graphite or the natural graphite flakes and the thermoplastic resin mixture. A method of manufacturing this molded product is described in detail when a method of manufacturing the fuel cell separating plate is described below.

In the embodiment, the fuel cell separating plate 100 is configured to have a structure in which the layers containing a high amount of graphite 120 are disposed on surfaces of the layer containing a small amount of graphite and a relatively high amount of the thermoplastic resin 110. The layers containing a high amount of graphite 120 are provided to increase electrical conductivity and the layer containing a small amount of graphite 110 is provided to increase gas sealability. In addition, when surfaces of the fuel cell separating plate 100 including the layers containing a high amount of graphite 120 are manufactured to become porous, a reactive area inside the fuel cell is enlarged, thus increasing battery efficiency.

Hereinafter, a method of manufacturing the fuel cell separating plate according to an embodiment is described in detail. A method of manufacturing the fuel cell separating plate according to the first embodiment of the present invention includes a step of mixing the expanded graphite and the thermoplastic resin, and a step of molding a mixture of the expanded graphite and the thermoplastic resin.

As described above, as the thermoplastic resin, a fluorocarbon polymer is preferred. More preferably, FEP, PFA, or PTFE as a fluorocarbon polymer, or a combination thereof is used.

Here, in the mixture of the expanded graphite and the thermoplastic resin, the expanded graphite may be included in an amount of 60 to 90 wt % and the fluorocarbon polymer may be included in an amount of 10 to 40 wt %.

The molding step may be carried out, for example, by compression-molding the mixture having the composition at 280 to 360° C. for 1 to 20 minutes.

In another embodiment, in the molding step, a molded product may be manufactured by extrusion-molding the expanded graphite and the fluorocarbon polymer and injection-molding a resultant extruded mixture at 280 to 360° C. for 1 to 20 minutes. Here, the content of the fluorocarbon polymer is increased to 30 to 40 wt % to facilitate injection-molding.

In yet another embodiment, the molding step may be carried out by manufacturing a sheet through extrusion of the mixture of the expanded graphite and the thermoplastic resin and compression-molding the manufactured sheet at 280 to 360° C. for 1 to 20 minutes. In another embodiment, molding time is shortened to one to three minutes by feeding the sheet, which is pre-heated to 280 to 360° C., manufactured by extruding the mixture to a compression-molding device, and thus a separating plate may be very quickly manufactured.

After the molding, a thermoplastic resin layer such as a fluorocarbon polymer may be excessively distributed on a surface of the molded separating plate, due to pressure applied during molding. Such a thermoplastic resin layer may decrease electrical conductivity of the separating plate. Accordingly, a process of removing the thermoplastic resin layer may be additionally carried out in order to enhance electrical conductivity. In an embodiment, the thermoplastic resin on the surface may be removed through blasting.

Hereinafter, a method of manufacturing a fuel cell separating plate according to a second embodiment is described in detail. Other configurations except those described below are the same those described in the method of manufacturing the fuel cell separating plate according to the first embodiment, and thus, descriptions therefor are omitted.

In the manufacturing method according to the second embodiment, a first carbon composite including 60 to 90 wt % of the expanded graphite and 10 to 40 wt % of the fluorocarbon polymer, and a second carbon composite including 91 to 95 wt % of the expanded graphite and 5 to 9 wt % of the fluorocarbon polymer are prepared. Subsequently, the prepared carbon composites are rolled together to manufacture a three-layer multilayer sheet in which a layer containing a small amount of graphite, composed of the first carbon composite locates between layers containing a high amount of graphite, composed of the second carbon composite. Here, the fluorocarbon polymer may be particularly FEP, PTFE, PFA, or a combination thereof.

In another embodiment, the layer containing a high amount of graphite may be prepared using a carbon composite including 85 to 92 wt % of the natural graphite flakes and 8 to 15 wt % of the fluorocarbon polymer. Here, the fluorocarbon polymer may be particularly FEP, PTFE, PFA, or a combination thereof.

Subsequently, the multilayer sheet is compression-molded at 280 to 360° C. for 1 to 20 minutes to manufacture a molded product. In another embodiment, the multilayer sheet pre-heated at 280 to 360° C. is fed into a compression-molding machine and molding time is shortened to 1 to 3 minutes. Accordingly, a separating plate may be very rapidly manufactured. A fuel cell separating plate manufactured according to the embodiment has a three layer structure and may be manufactured by compression-molding once through sheet manufacturing.

In addition, as in the first embodiment described above, an excessive thermoplastic resin layer formed on a surface after the compression-molding may be removed through blasting.

Hereinafter, experimental examples are described in detail to confirm effects of the fuel cell separating plate according to the present invention. Experimental examples described below are provided to exemplify the presently described embodiments and the present disclosure is not limited to conditions of the experimental example below.

### Experimental Example 1

Molded products for fuel cell separating plates were manufactured using expanded graphite and FEP resin, and conductivity, flexural strength, and gas sealability according to composition change of the expanded graphite and the FEP resin were confirmed. Results are summarized in Table 1 below.

TABLE 1

| | Composition ratio (wt %) of expanded | | | | | | |
|---|---|---|---|---|---|---|---|
| | graphite:FEP resin | | | | | | |
| | 60:40 | 65:35 | 70:30 | 75:25 | 80:20 | 85:15 | 90:10 |
| Conductivity (S/cm) | 88 | 97 | 105 | 111 | 117 | 122 | 129 |
| In-plane | | | | | | | |
| flexural strength | 58 | 54 | 52 | 52 | 48 | 46 | 40 |
| (MPa) | | | | | | | |
| Gas sealability | No | No | No | No | No | No | No |
| (cc/min) | leak | leak | leak | leak | leak | leak | leak |

As shown in Table 1, with decreasing FEP content, conductivity is enhanced and flexural strength is decreased. However, the flexural strength is maintained such that the molded products may be used as high temperature and corrosion resistant fuel cell separating plates. In particular, it can be confirmed that gas sealability is maintained due to characteristics of combinations of the expanded graphite and the FEP resin even when the content of the FEP resin is about 10 w %.

It can be confirmed that, even when the amount of the expanded graphite in the carbon composite is about 60 wt %, among compositions of Table 1, electrical conductivity sufficiently applicable to a fuel cell is exhibited. Accordingly, it can be confirmed that, in the case of a highly conductive fuel cell separating plate, the amount of the conductive material may be properly maintained and thus the separating plate may be more easily molded.

In particular, so as to secure fluidity of a material during injection-molding, a large amount of resin having satisfactory fluidity is required. However, conventional methods have difficulties in that injectability should be secured while increasing the amount of conductive filler. In the case of the carbon composite prepared according to the experimental example, the FEP resin may be added in an amount of up to 30 to 40%, and thus, it is judged injection-molding to be very advantageously used upon manufacturing of the fuel cell separating plate according to the present invention.

In addition, the carbon composite prepared according to the present invention has high fluidity, and thus, thickness variation in a separating plate is decreased during compression-molding.

Conductivity, flexural strength, and air tightness of carbon composite compositions summarized in Table 1 may be secured, and thus, a fuel cell separating plate may be manufactured through a simple process of compression-molding at 280 to 360° C. for 1 to 20 minutes.

### Experimental Example 2

Carbon composites for porous separating plates were prepared, and conductivity, flexural strength and gas sealability thereof were measured. Table 2 shows results for experimental examples in which the content of the expanded graphite in each of mixtures of the FEP resin and the expanded graphite was 91 to 95%. Table 3 shows results for experimental examples in which each of the carbon composites includes the natural graphite flakes in an amount of 85 to 92%.

TABLE 2

Composition ratio (wt %) of expanded
graphite:FEP resin

| | 91:9 | 93:7 | 95:5 |
|---|---|---|---|
| Conductivity (S/cm) | 128 | 134 | 145 |
| In-plane | | | |
| Flexural strength | 38 | 35 | 33 |
| (MPa) | | | |
| Gas sealability | 0.1 to 1 | 1 to 10 | 10< |
| (cc/min) | | | |

TABLE 3

Composition ratio (wt %) of natural
graphite flake:FEP resin

| | 85:15 | 92:8 |
|---|---|---|
| Conductivity (S/cm) | 102 | 114 |
| In-plane | | |
| Flexural strength | 45 | 38 |
| (MPa) | | |
| Gas sealability | 0.1 to 1 | 1 to 10 |
| (cc/min) | | |

It is confirmed that a fuel cell separating plate having a porosity of 0.1 to 10 cc/min or more may be manufactured by molding the carbon composite. A carbon composite prepared as described above may be applied to the layer containing a high amount of graphite of the fuel cell separating plate illustrated in FIG. 1.

Although the embodiments herein have been disclosed for illustrative purposes, those skilled in the art will appreciate that various modifications, additions and substitutions are possible, without departing from the scope and spirit of the disclosure.

1. A fuel cell separating plate, comprising a molded product manufactured from a mixture of expanded graphite and thermoplastic resin.

2. The fuel cell separating plate according to claim 1, wherein the thermoplastic resin is a fluorocarbon polymer.

3. The fuel cell separating plate according to claim 2, wherein the fluorocarbon polymer is fluorinated ethylene propylene (FEP), polytetrafluoroethylene (PTFE), perfluoroalkoxy (PFA), or a combination thereof.

4. The fuel cell separating plate according to claim 3, wherein the molded product comprises 60 to 90 wt % of the expanded graphite and 10 to 40 wt % of the fluorocarbon polymer.

5. The fuel cell separating plate according to claim 4, wherein the molded product comprises 60 to 70 wt % of the expanded graphite and 30 to 40 wt % of the fluorocarbon polymer.

6. The fuel cell separating plate according claim 1, wherein the molded product is manufactured by compression-molding, injection-molding, extrusion-molding, or a combination of two or more thereof.

7. The fuel cell separating plate according to claim 1, wherein the molded product comprises:
a layer containing a small amount of graphite, comprising the expanded graphite and the thermoplastic resin, and
a layer containing a high amount of graphite, comprising the thermoplastic resin in a smaller amount than the layer containing a small amount of graphite and disposed on two opposite sides of the layer containing a small amount of graphite.

8. The fuel cell separating plate according to claim 7, wherein the layer containing a small amount of graphite comprises 60 to 90 wt % of the expanded graphite and 10 to 40 wt % of the fluorocarbon polymer, and
the layer containing a high amount of graphite comprises 91 to 95 wt % of the expanded graphite and 5 to 9 wt % of the fluorocarbon polymer.

9. The fuel cell separating plate according to claim 7, wherein the layer containing a small amount of graphite comprises 60 to 90 wt % of the expanded graphite and 10 to 40 wt % of the fluorocarbon polymer, and
the layer containing a high amount of graphite comprises 85 to 92 wt % of natural graphite flakes and 8 to 15 wt % of the fluorocarbon polymer.

10. The fuel cell separating plate according to claim 7, wherein the layer containing a high amount of graphite has a porosity of 0.1 to 10 cc/min or more.

11. A method of manufacturing a fuel cell separating plate, the method comprising:
mixing expanded graphite and thermoplastic resin, and
molding a mixture of the expanded graphite and the thermoplastic resin.

12. The method according to claim 11, wherein the thermoplastic resin is a fluorocarbon polymer.

13. The method according to claim 12, wherein the fluorocarbon polymer is any one of FEP, PTFE, and PFA.

14. The method according to claim 13, wherein the mixture comprises 60 to 90 wt % of the expanded graphite and 10 to 40 wt % of the fluorocarbon polymer.

15. The method according to claim 14, wherein the molding comprises compression-molding the mixture at 280 to 360° C. for 1 to 20 minutes.

16. The method according to claim 14, wherein the mixing comprises extrusion-molding the expanded graphite and the fluorocarbon polymer, and the molding comprises injection-molding the mixture at 280 to 360° C. for 1 to 20 minutes.

17. The method according to claim 16, wherein the mixture comprises 60 to 70 wt % of the expanded graphite and 30 to 40 wt % of the fluorocarbon polymer.

18. The method according to claim 14, wherein the molding comprises:
extruding the mixture to prepare a sheet, and
compression-molding the sheet at 280 to 360° C. for 1 to 20 minutes.

19. The method according to claim 13, wherein the mixing comprises preparing a first carbon composite by mixing 60 to 90 wt % of the expanded graphite and 10 to 40 wt % of the fluorocarbon polymer, and preparing a second carbon composite by mixing 91 to 95 wt % of the expanded graphite and 5 to 9 wt % of the fluorocarbon polymer, and
the molding comprises preparing a multilayer sheet by rolling the first carbon composite and the second carbon composite such that a layer containing a small amount of graphite, composed of the first carbon composite is disposed between two layers containing a high amount of graphite, composed of the second carbon composite, and compression-molding the multilayer sheet at 280 to 360° C. for 1 to 20 minutes.

20. The method according to claim 13, wherein the mixing comprises preparing a first carbon composite comprising 60 to 90 wt % of the expanded graphite and 10 to 40 wt % of the fluorocarbon polymer, and preparing a second carbon composite comprising 85 to 92 wt % of natural graphite flakes and 8 to 15 wt % of the fluorocarbon polymer, and
the molding comprises preparing a multilayer sheet by rolling the first carbon composite and the second carbon composite such that a layer containing a small amount of graphite, composed of the first carbon composite is disposed between two layers containing a high amount of graphite, composed of the second carbon composite, and compression-molding the multilayer sheet at 280 to 360° C. for 1 to 20 minutes.

21. The method according to claim 11, further comprising, after the molding, removing the thermoplastic resin distributed on a surface of the molded separating plate.

22. The method according to claim 21, wherein the removing comprises removing the thermoplastic resin through blasting.
